(19) United States
(12) Patent Application Publication
(10) Pub. No.: US 2015/0358261 A1
(43) Pub. Date: Dec. 10, 2015

(54) PLAYBACK METHOD AND ASSOCIATED TRANSMITTING DEVICE, PLAYBACK DEVICE, AND COMMUNICATION SYSTEM

(71) Applicant: Wistron Corporation, New Taipei City (TW)

(72) Inventors: Lee-Chun Ko, New Taipei City (TW); Wei-Lun Liu, New Taipei City (TW)

(21) Appl. No.: 14/589,010

(22) Filed: Jan. 5, 2015

(30) Foreign Application Priority Data
Jun. 4, 2014 (TW) 103119342

(51) Int. Cl. H04L 12/58

(52) U.S. Cl. CPC H04L 51/046; H04L 51/10

(57) ABSTRACT

A playback method and associated transmitting device, playback device and communication system are provided. The communication system includes the transmitting device and the playback device, which are in communication with each other. The transmitting device transmits a bitstream profile tag to the playback device. After receiving the bitstream profile tag, the playback device plays a selected range of a target bitstream according to the bitstream profile tag.

This application claims the benefit of Taiwan application Serial No. 103119342, filed Jun. 4, 2014, the subject matter of which is incorporated herein by reference.

### BACKGROUND OF THE INVENTION

1. Field of the Invention

The invention relates in general to a playback method and associated transmitting device, playback device and communication system, and more particularly to a playback method applied to instant messaging, and associated transmitting device, playback device and communication system.

2. Description of the Related Art

With the development of network, instant messaging software, such as the early MSN, Skype and the like, has become the communication tool used by peoples. In addition to the personal computer that can execute the instant messaging software through the network connection, the rise of the mobile device further drives a new wave of the instant messaging software. Nowadays, the instant messaging software, such as WhatsApp, Line, WeChat and the like, becomes indispensable for users using mobile devices such as a mobile phone or a tablet.

The instant messaging software, such as Line, WhatsApp, WeChat, Skype and the like, provides diversified communication ways for the users. For example, the users can transmit text messages, files, videos, icons and the like through the instant messaging software. In addition, many kinds of instant messaging software further provide the users the personal voice recording and video recording functions, and the functions of transmitting the recorded voice and video files.

Many kinds of instant messaging software provide the icon posting function, and attract more users through cuter emotion icons. When the user runs out of words, the emotion icons can assist the user in expressing feelings and emotions. In other words, the use of the emotion icons can make the user express the thoughts and feelings more deeply and quickly. As a result, the icon posting functions of the instant messaging software have seized a market of business opportunity.

In addition to the icon posting function, clips of some songs or videos may reflect the users personal feelings and emotions. Thus, the function of real-time transmitting the video is also desired by the user. However, the conventional instant messaging software cannot effectively provide such function.

FIG. 1 is a schematic view showing concept of a conventional video clip sharing method. For the sake of illustration, it is assumed that the user A and the user B are talking to each other using the instant messaging software. The user A operates a transmitting device 11, the user B operates a playback device 13, and the user A wishes to transmit a video clip to the user B. In order to transmit the suitable video clip, the user A has to utilize the conventional transmitting device 11 to select and edit a clip of a video stream (that is, video clip).

First, the user A needs to obtain a complete video stream (that is, a target stream) containing the video clip, and manually cuts the target stream. At first, the transmitting device 11 downloads the target stream from a stream providing platform 17 (step S11). Then, the user A utilizes the transmitting device 11 to edit the target stream and thus the transmitting device 11 generates a stream clip (step S13). The stream clip is a portion of the target stream representing content of the video clip to be shared by the user A. Next, the transmitting device 11 transmits the stream clip to the playback device 13 (step S15). Finally, the user B utilizes the playback device 13 to play the stream clip (step S17).

When the prior art adopts the video clip sharing approach of FIG. 1, the communication system may cause the following problems.

First, the user must spend a lot of time to search for the target stream, and manually edit the target stream to retrieve the stream clip. The processes of searching for the target stream and editing the target stream to retrieve the stream clip are too complicated and time-consuming. Consequently, the instant messaging effect is dramatically affected.

Second, the user A may only have vague impression of a certain video clip and does not know the exact playback timing of the video clip. Thus, the user A must download and search the complete target stream before editing the target stream. Both the target stream and the stream clip contain the video data, and the video data includes the larger amount of data quantity. Consequentially, the conventional method of sharing video clip needs the user to spend time for downloading and/or transmitting the target stream and the stream clip, and further causes the bandwidth occupying problem in the communication system. When the steps S11 and S15 are performed, a lot of bandwidths of the communication system may be occupied.

Furthermore, the copyright of the target stream may affect the playback method of the user. If the target stream found by the user A only provides the playback authority but does not provide the download authority, then the user A cannot edit the target stream. At this time, the user A needs to find and transmit the uniform resource locator (hereinafter, URL) of the target stream to the user B, and inform the playback start time and the playback end time to the user B. This conventional method of sharing the video clip brings inconvenience to both users A and B.

### SUMMARY OF THE INVENTION

The invention is directed to a playback method and associated transmitting device, playback device and communication system.

According to a first aspect of the present invention, a communication system is provided. The communication system includes a transmitting device and a playback device. The transmitting device transmits a bitstream profile tag. The playback device is in communication with the transmitting device. The playback device receives the bitstream profile tag and then accordingly plays a playback range of a target stream.

According to a second aspect of the present invention, a transmitting device in communication with a playback device is provided. The transmitting device includes an input unit and a transmitting unit. The input unit is for inputting a keyword. The transmitting unit transmits a bitstream profile tag, wherein the bitstream profile tag is generated according to the keyword. Then, the playback device plays a playback range of a target stream according to the bitstream profile tag.

According to a third aspect of the present invention, a playback device in communication with a transmitting device is provided. The playback device includes a receiving unit and a playback unit. The receiving unit receives a bitstream profile tag transmitted by the transmitting device. The playback unit plays a playback range of a target stream according to the bitstream profile tag.

According to a fourth aspect of the present invention, a playback method applied to a playback device is provided. The playback method includes the steps of selecting a target stream according to a bitstream profile tag; and playing a playback range of the target stream according to the bitstream profile tag.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) is a schematic view showing a conventional video clip sharing method;

FIG. 2 is a schematic view showing concept of a video clip sharing method according to the invention;

FIG. 3 is a schematic view showing concept of a communication system according to an embodiment of the invention;

FIG. 4 is a schematic view showing the invention establishing the mapping relationship between the subtitle and the stream;

FIG. 5 is a schematic view showing the invention representing a playback range using a bitstream profile tag;

FIG. 6A is a block diagram showing a transmitting device according to the embodiment of the invention;

FIG. 6B is a block diagram showing a stream searching platform according to the embodiment of the invention;

FIG. 6C is a block diagram showing a playback device according to the embodiment of the invention;

FIG. 7 is a flow chart showing the transmitting device of the invention;

FIG. 8 is a flow chart showing a stream searching platform of the invention;

FIG. 9 is a flow chart showing a playback device of the invention;

FIG. 10 is a schematic view showing a communication system implementing a communication method according to one embodiment;

FIG. 11 is a schematic view showing a communication system implementing a communication method according to another embodiment; and

FIG. 12 is a schematic view showing a communication system implementing a communication method according to still another embodiment.

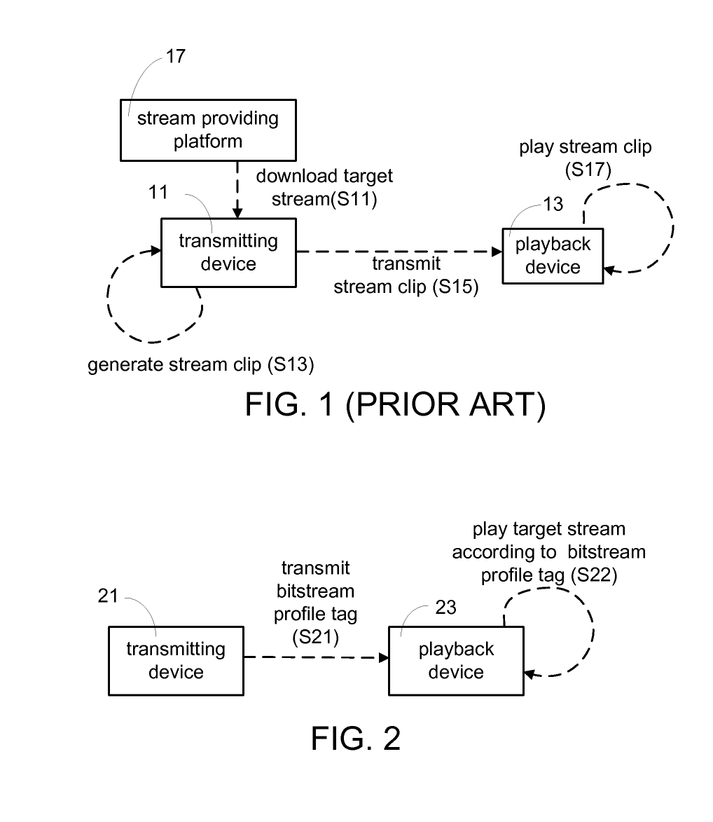

### DETAILED DESCRIPTION OF THE INVENTION

Many film clips or lyrics have many implied meanings, and the user can select video clips according to different chat conditions. The invention provides the users a quick and convenient method to transmit arbitrary video clips. Incidentally, instant messaging software adopting the invention can express the users mood more rapidly and appropriately.

FIG. 2 is a schematic view showing concept of a video clip sharing method according to the invention. Referring to FIG. 2, a transmitting device 21 transmits a bitstream profile tag to a playback device 23 (step S21). After receiving the bitstream profile tag, the playback device 23 can directly play contents of a target stream according to the bitstream profile tag (step S22).

According to the idea of the invention, the transmitting device 21 needs not to actually edit and generate the stream clip, nor to transmit the stream clip to the playback device 23. The concept of the bitstream profile tag proposed in this invention enables the playback device 23 to be able to directly play the video clip by referring to the bitstream profile tag. In other words, instead of actually transmitting steam clip containing the video clip, a bitstream profile tag is transmitted for indicating where to find the original stream and how to play the video clip. The bitstream profile tag utilizes texts to record the information associated with the video clip. Thus, transmitting the bitstream profile tag can significantly save the bandwidth of the communication system.

The transmitting device 21 of the invention needs not to actually generate and share the video clip, but makes the playback device 23 be able to refer to the contents of the bitstream profile tag, thereby achieving the effect of sharing and playing the video clip. The transmitting device 21 can store the bitstream profile tag in advance or receive the bitstream profile tag from a stream searching platform (not shown). The details associated with the bitstream profile tag will be described later.

According to the idea of the invention, plural original streams representing various video contents are stored in a stream providing platform. When the type of an original stream is a video program, the full text strings corresponding to the original stream may be subtitles, asides or the like of the video program. Alternatively, when content of the original stream is a song, the full text strings corresponding to the original stream may be lyrics of the song.

The playback device 23 obtains the storage position of the target stream according to the content of the bitstream profile tag, and is thus connected to the stream providing platform. The stream providing platform provides various types of video streams (original streams) to be played or downloaded by the playback device 23. The video content database in the stream providing platform may be established by a service provider, the user or a third-party network video service provider (for example, YouTube, YouKu or the like). In addition, the stream providing platform may also be integrated into the stream searching platform. In other words, the implementation methods of the stream providing platform and the stream searching platform need not to be restricted.

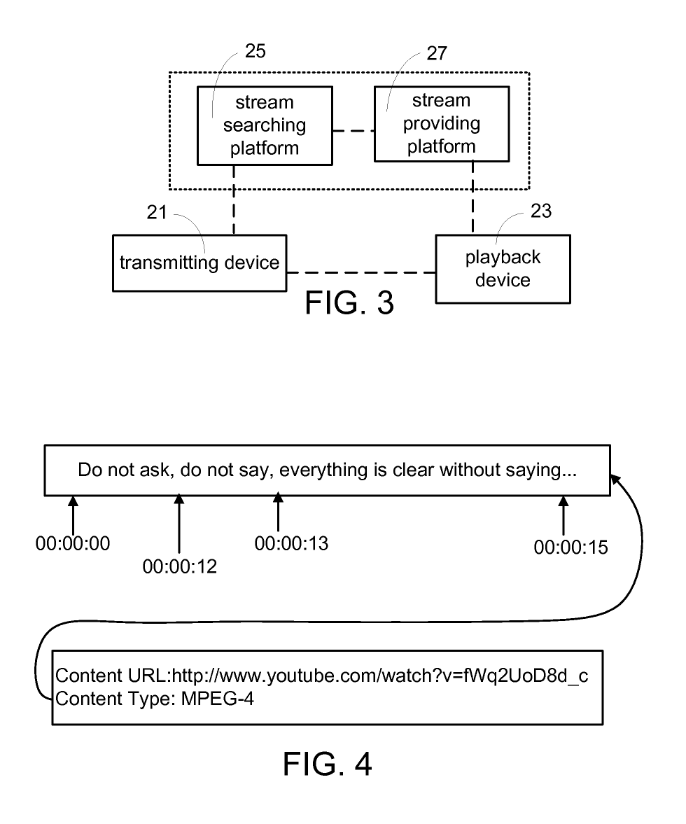

FIG. 3 is a schematic view showing a communication system according to an embodiment of the invention. Referring to FIG. 3, the communication system of the invention includes the transmitting device 21, the playback device 23 and a stream searching platform 25. In addition, the communication system may be used in conjunction with a stream providing platform 27. The transmitting device 21 is in communication with the stream searching platform 25 and the playback device 23.

The stream providing platform 27 is in communication with the stream searching platform 25 and the playback device 23. The stream providing platform 27 stores plural original streams. It is assumed that the target stream is one of the original streams. The number of the stream providing platform(s) 27 needs not to be restricted.

The stream searching platform 25 provides multiple mapping relationships between the original stream, a playback timing and a full text string. For example, regarding an original stream having data content as a song, the stream searching platform 25 records a plural playback timings corresponding to the song, and the lyrics corresponding to each of the playback timings. Also, regarding another original stream having data content as a film, the stream searching platform 25 records a plural playback timings corresponding to the film, and the subtitles corresponding to each of the playback timings. These lyrics of the songs and the subtitles of the film are stored in the form of full text strings. Theses stored full text strings may be searched as keywords.

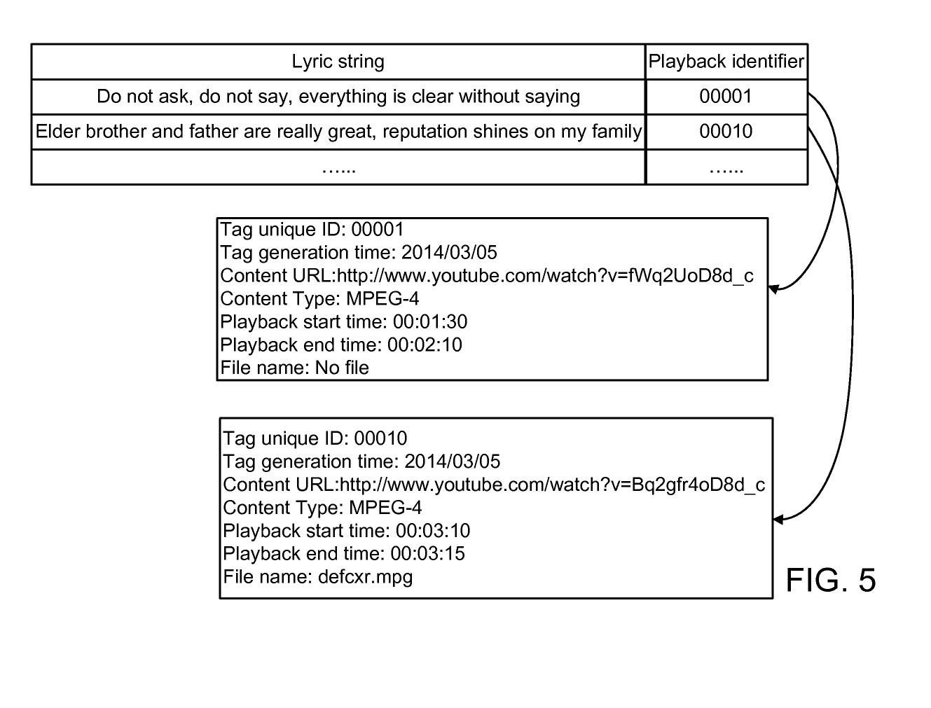

FIG. 4 is a schematic view showing the invention establishing the mapping relationship between the subtitle and the original stream. Referring to FIG. 4, many current video playback techniques adopt the time stamp to represent the playback timing of the original stream. Of course, the actually recorded format of the time stamp is not necessarily to be the same as the playback timing (hour/minute/second) of the user's habit, but may adopt other encoding formats or sorting methods in conjunction with the displayed frame. This portion pertains to the application of the video playback technique, and will not be described in detail.

The invention utilizes the stream searching platform 25 to store the mapping relationships between the full text strings of multiple original streams and the time stamps of the original streams. In addition, the stream searching platform 25 also correspondingly stores the storage positions of the original streams. The storage positions of the original streams need not to be restricted. For example, the storage position may be a uniform resource locator (hereinafter, URL), or the stream providing platform in the same intranet and the like.

The stream searching platform 25 utilizes a mapping unit to establish and store the mapping relationships between these time stamps and the full text strings. For example, a database of the full text strings is built in the mapping unit, and the keyword search function can be provided. Therefore, the stream searching platform 25 can subsequently perform the keyword searching on the database of the full text strings according to the keyword inputted by the user A. In addition, after a playback string is decided, the playback range of the original stream representing the playback duration (for example, playback start time, playback end time) corresponding to the playback string can be obtained. The playback string represents the aside string, subtitle string, lyric string or the like corresponding to the playback range.

For example, in FIG. 4, the playback string designated by the user A is the lyric string of “Do not ask, do not say, everything is clear without saying”. The mapping unit can obtain a playback start time (for example, “00:00:00” of FIG. 4) and a playback end time (for example, “00:00:15” of FIG. 4) corresponding to the playback string. Thus, the playback range of the selected original stream, that is, the song “Blessing” being the target stream, corresponds to the contents to be played during 00:00:00 to 00:00:15.

FIG. 5 is a schematic view showing the invention representing a playback range using a bitstream profile tag. According to the idea of the invention, the stream searching platform 25 generates and records the bitstream profile tag according to the information, such as the target stream, the playback range and/or the like.

According to the present invention, the bitstream profile tag is correspondingly generated according to the video clip to be shared by the user, and a playback identifier with uniqueness is assigned with respect to the bitstream profile tag. Therefore, even if the same target stream is selected, when the selected playback ranges are different, a label generating unit 251 correspondingly generates different bitstream profile tags and different playback identifiers.

In this drawing, the lyric string “Do not ask, do not say, everything is clear without saying” corresponds to the playback identifier “00001”; while the lyric string “Elder brother and father are really great, reputation shines on my family” corresponds to the playback identifier “00010”. The playback identifier “00001” and the playback identifier “00010” respectively corresponds to one bitstream profile tag.

The bitstream profile tag may include the information associated with the video clip to shared. The information may be, for example, the storage position of the target stream, the playback range (the playback start time, the playback end time), the playback string, the playback identifier, the provider of the target stream, the time of generating the target stream, and the like. Of course, other information associated with the playback range may also be recorded in the bitstream profile tag.

The contents of the playback identifier and the bitstream profile tag are generated according to the stream information of the selected video clip. In other words, mapping between the contents of the playback identifier, the bitstream profile tag and the video clip is unique. Therefore, the playback device 23 can identify the playback range according to the playback identifier or the bitstream profile tag.

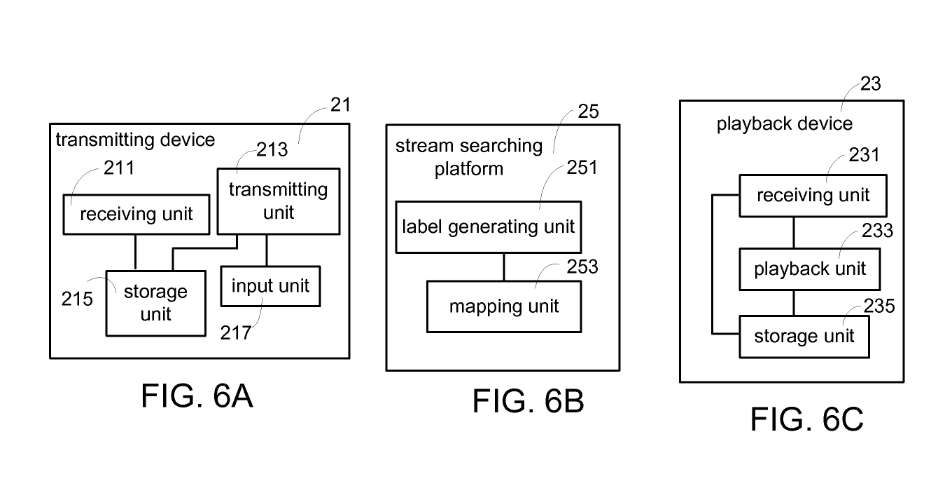

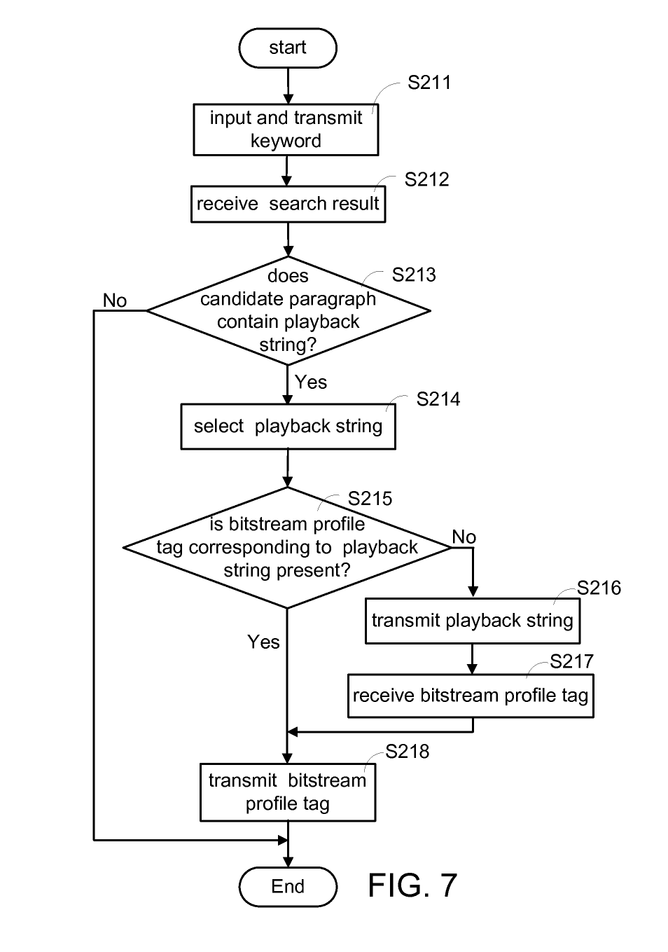

In the following, the inner architectures of the transmitting device 21, the stream searching platform 25 and the playback device 23 of the invention will be described with reference to FIGS. 6A to 6C, respectively. The detailed operation flows of these devices will be described in FIGS. 7 to 9.

FIG. 6A is a block diagram showing a transmitting device according to the embodiment of the invention. Referring to FIG. 6A, the transmitting device 21 includes a receiving unit 211, a transmitting unit 213, a storage unit 215 and an input unit 217. The receiving unit 211 and the transmitting unit 213 are electrically connected to the storage unit 215. The input unit 217 is electrically connected to the transmitting unit 213. Both of the receiving unit 211 and the transmitting unit 213 are in communication with the stream searching platform 25 and the playback device 23.

The transmitting device 21 utilizes the receiving unit 211 to receive the bitstream profile tag from the stream searching platform 25. The transmitting device 21 utilizes the transmitting unit 213 to transmit the keyword to the stream searching platform 25, and to transmit the bitstream profile tag to the playback device 23. Every time when the transmitting device 21 receives a new bitstream profile tag, the transmitting device 21 can synchronously update data contents in the storage unit 215. Therefore, if the user A needs to share the same video clip again, the data contents in the storage unit 215 can be utilized to accelerate the process of acquiring and transmitting the bitstream profile tag. That is, the stored bitstream profile tag can be efficiently transmitted to either the same transmission object or a different transmission object.

FIG. 6B is a block diagram showing a stream searching platform according to the embodiment of the invention. Referring to FIG. 6B, the stream searching platform 25 includes the label generating unit 251 and a mapping unit 253. The label generating unit 251 is in communication with the transmitting device 21, while the mapping unit 253 is in communication with the stream providing platform 27. Upon the practical application, the label generating unit 251 and the mapping unit 253 in the stream searching platform 25 may utilize two separate servers, or share the same server.

Furthermore, the stream searching platform 25 and the stream providing platform 27 may be provided by the same provider or different providers. For example, it is assumed that the stream providing platform 27 is the Youtube website, and the stream searching platform 25 is provided by a telecommunication company. Alternatively, a cloud service provider provides the stream searching platform 25 and the stream providing platform 27 concurrently.

FIG. 6C is a block diagram showing a playback device according to the embodiment of the invention. Referring to FIG. 6C, the playback device 23 is in communication with the stream providing platform 27 and the transmitting device 21. The playback device 23 includes a receiving unit 231, a playback unit 233 and a storage unit 235 which are electrically connected to another. Upon the practical application, the functions of the transmitting device 21 and the playback device 23 may be commonly integrated into a portable device, such as a mobile phone, a tablet or the like.

The receiving unit 231 receives the bitstream profile tag transmitted by the transmitting device 21. The playback unit 233 plays the playback range in the target stream according to the bitstream profile tag. The storage unit 235 may store the bitstream profile tag, and the playback range corresponding to the stored bitstream profile tag. The storage unit 235 can increase the speed of sharing the video clip in the instant messaging software.

For example, it is assumed that the playback device 23 has stored the playback identifier “00010” and its corresponding playback range. Thereafter, when the playback device 23 again receives another bitstream profile tag, the playback identifier reads from the playback identifier field of the bitstream profile tag and finds out the playback identifier is “00010”. In addition, it is assumed that the playback device 23 discovers that the playback identifier “00010” has been present in the storage unit 235. In this case, the playback unit 233 of the playback device 23 can directly play the playback range corresponding to the playback identifier “00010”.

FIG. 7 is a flow chart showing the transmitting device of the invention. First, the input unit 217 retrieves the keyword inputted by the user, and the transmitting unit 213 transmits the keyword to the stream searching platform 25 (step S211). Second, the receiving unit 211 receives a search result from the stream searching platform 25 (step S212).

The search result may be that the stream searching platform 25 cannot find any full text string containing the keyword. Alternatively, the search result may be that the stream searching platform 25 has found more than one candidate full text string. For example, if the keyword inputted by the user is “rain”, then the stream searching platform 25 may find many lyrics of songs (that is, full text strings) containing the keyword “rain”. For the sake of illustration, the full text strings containing the keyword are referred to as candidate full text strings. In this example, these lyrics of songs containing the keyword “rain” are the candidate full text strings.

Following the above-mentioned example, the stream searching platform 25 does not transmit all lyrics of the found songs (that is, all the candidate full text strings) back to the transmitting device 21. According to the idea of the invention, the stream searching platform 25 further excerpts the candidate full text strings and only transmits back the portion containing the keyword. In other words, the stream searching platform 25 only transmits back the paragraph of the context containing “rain”. These excerpted lyric paragraphs are referred to as candidate paragraphs. If many portions in the same song contain the term “rain”, the stream searching platform 25 may also generate multiple candidate paragraphs according to the same candidate full text string.

Next, the user can learn that there are multiple candidate songs containing the keyword “rain” according to the candidate paragraphs transmitted back to the transmitting device 21. In addition, because the lyric paragraphs (that is, candidate paragraphs) containing the keyword “rain” in the these candidate songs have been listed, the user can easily determine whether there is any candidate paragraph, which is among these candidate paragraphs, contains his/her desired playback string (step S213).

The user A can utilize the input unit 217 (for example, touch screen) to select one of the candidate paragraphs, that is, to confirm which one is the song he/she desires. For example, after the transmitting device 21 displays multiple candidate paragraphs (that is, part of lyrics of the plural songs containing the keyword), the user selects the desired lyric range through the touch function. The range of the lyrics actually selected by the user is the playback string. Thereafter, the transmitting device 21 further transmits the playback string to the stream searching platform 25 through the transmitting unit 213.

Incidentally, when the same song is covered by multiple singers, an auxiliary determining method may be additionally provided. Thus, the user can determine to select the candidate paragraph according to the context of the keyword as well as the meta data, such as the singer, the genre or the like. According to the description, the representation of the search method does not affect the idea of the invention.

If the determination result of the step S213 is negative, the procedure ends. If the determination result of the step S213 is affirmative, the actually desired playback string is selected from these candidate paragraphs (step S214). In addition, it is determined whether the transmitting device 21 has stored the bitstream profile tag corresponding to the playback string (step S215). If the determination result of the step S215 is affirmative, the transmitting device 21 can directly transmit the bitstream profile tag to the playback device 23 (step S218).

If the determination result of the step S215 is negative, the transmitting device 21 transmits the playback string back to the stream searching platform 25 (step S216). The transmitting device 21 firstly receives the bitstream profile tag from the stream searching platform 25 (step S217), and then transmits the bitstream profile tag to the playback device 23 (step S218).

It is to be noted that after the transmitting device 21 receives the bitstream profile tag from the stream searching platform 25, the storage unit 215 can be utilized to store the bitstream profile tag. Consequently, if the user A encounters the similar situation in the future, and wants to share the same video clip to other users, then the bitstream profile tag stored in the storage unit 215 can be directly utilized, thereby increasing the sharing speed of the instant messaging software.

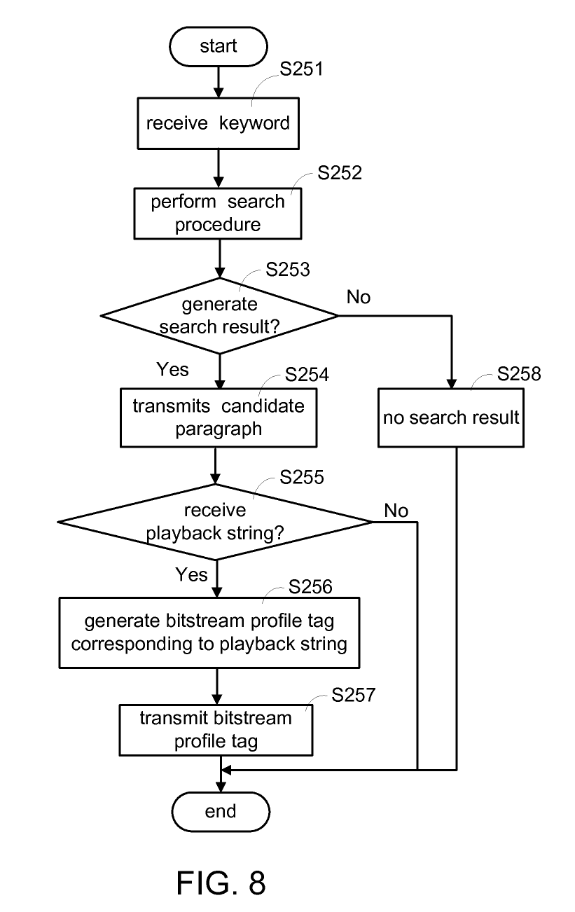

FIG. 8 is a flow chart showing a stream searching platform of the invention. In short, the stream searching platform 25 performs a search procedure on the full text strings according to the keyword after receiving the keyword from the transmitting device 21. The result generated in the search procedure is used to generate the bitstream profile tag.

First, the stream searching platform 25 receives the keyword transmitted by the transmitting device 21 (step S251). The search procedure is performed according to the keyword (step S252). The details of the step S252 need not to be restricted. In other words, the method of searching the stream full texts in the stream searching platform 25 is very flexible.

Next, the stream searching platform 25 determines whether to generate the search result or not (step S253) according to the search result of the database of the full text strings. The execution result of the step S253 may be that the keyword is not found. At this time, an error message representing that the keyword cannot be found is transmitted back to the transmitting device 21 (step S258). The execution result of the step S253 may be that one or more full text strings (candidate full text strings) containing the keyword are found. In this case, the mapping unit 253 excerpts the portion, containing the keyword, from the candidate full text string as the candidate paragraph, and transmits the candidate paragraph to the transmitting device 21 (step S254).

Then, the stream searching platform 25 determines whether the transmitting device 21 has transmitted back the playback string (step S255). If not, it represents that the transmitting device 21 itself has stored the bitstream profile tag in advance, and it is unnecessary to obtain the bitstream profile tag from the stream searching platform 25. So, the procedure of the stream searching platform 25 can be ended.

If the determination result of the step S255 is affirmative, the stream searching platform 25 generates the bitstream profile tag according to the playback string (step S256). Thereafter, the bitstream profile tag is transmitted to the transmitting device 21 (step S257).

After receiving the candidate paragraphs, the transmitting device 21 selects the playback string from one of the candidate paragraphs according to the users selection operation. Thereafter, the transmitting device 21 transmits the playback string back to the stream searching platform 25. After receiving the playback string, the mapping unit 253 can confirm the full text string to which the playback string pertains, and obtain the time stamp corresponding to the playback string according to the mapping relationship between the time stamp and the full text strings. Thereafter, the label generating unit 251 can generate the bitstream profile tag according to the information, such as the playback string and the time stamp.

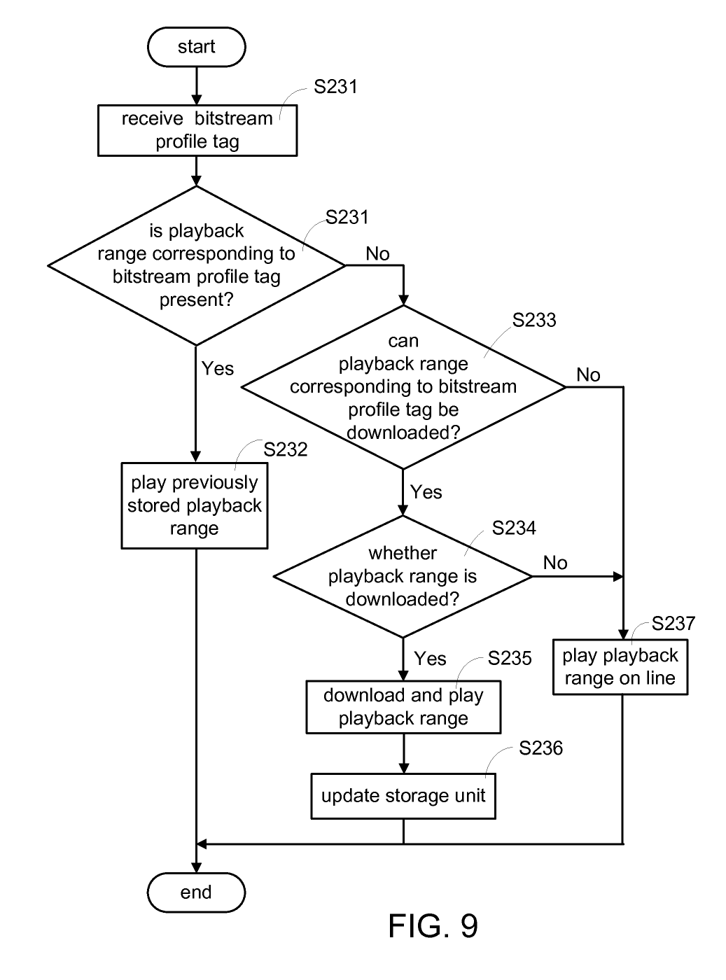

FIG. 9 is a flow chart showing a playback device of the invention. First, the playback device 23 receives the bitstream profile tag from the transmitting device 21 (step S231). Next, it is determined whether the internal storage unit 235 previously stores the playback range corresponding to the bitstream profile tag (step S231). The determination may be made by comparing the playback identifier in the bitstream profile tag. If determination result of step S231 is affirmative, the previously stored playback range is directly played by the playback device 23 (step S232).

If the determination result of the step S231 is negative, it represents that the playback device 23 must obtain the playback range from the stream providing platform 27. At this time, two conditions are further classified according to whether the target stream itself can be downloaded. The first condition is that the target stream is restricted by the copyright issue, thereby the stream providing platform 27 is disabled from providing the download function. At this time, the playback device 23 directly plays the playback range of the target stream in an online playback manner (step S237).

If the target stream can be downloaded, the user is further provided with an option to determine whether the user wishes to download the steam clip, that is, portion of the target stream which is corresponding to the playback range (step S234). If not, the playback device 23 plays the playback range in an online playback manner (step S237). If the user agrees, then the playback device 23 downloads and plays the stream clip (step S235). In addition, the playback device 23 stores the playback identifier (step S236).

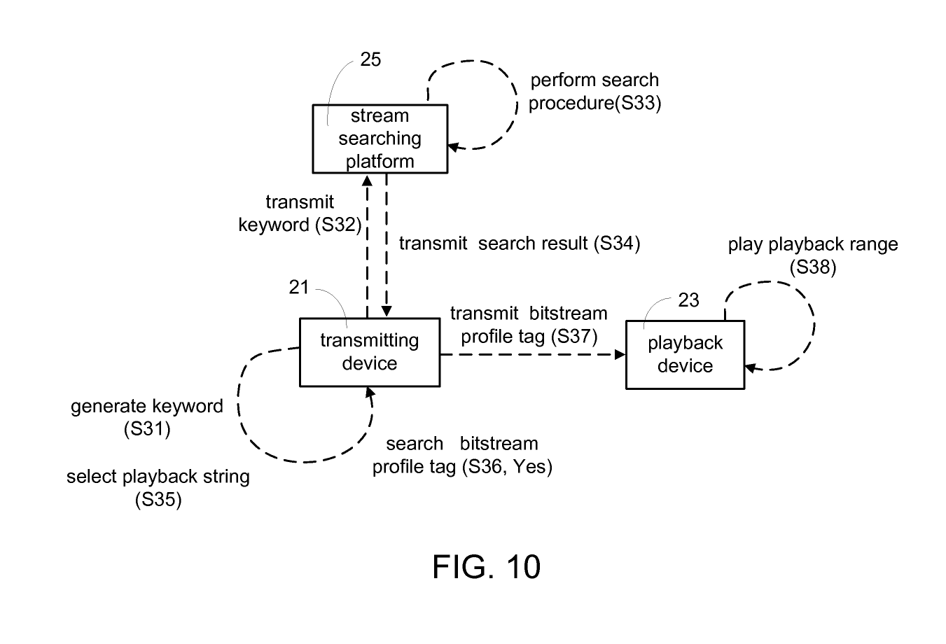

The flow chart has described the internal operation flow of each device in the communication system. Moreover, how the devices in the communication system perform the interaction under various different conditions will be described in the following. In FIGS. 10 to 12, the execution of each step will be represented by the arrow direction. In order to simplify the illustration, some more detailed steps or possible application changes will not be labeled.

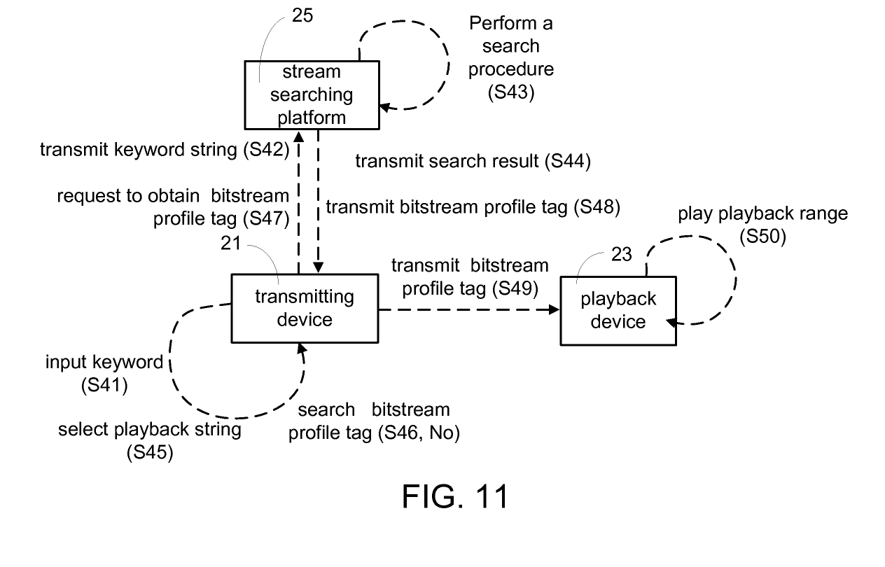

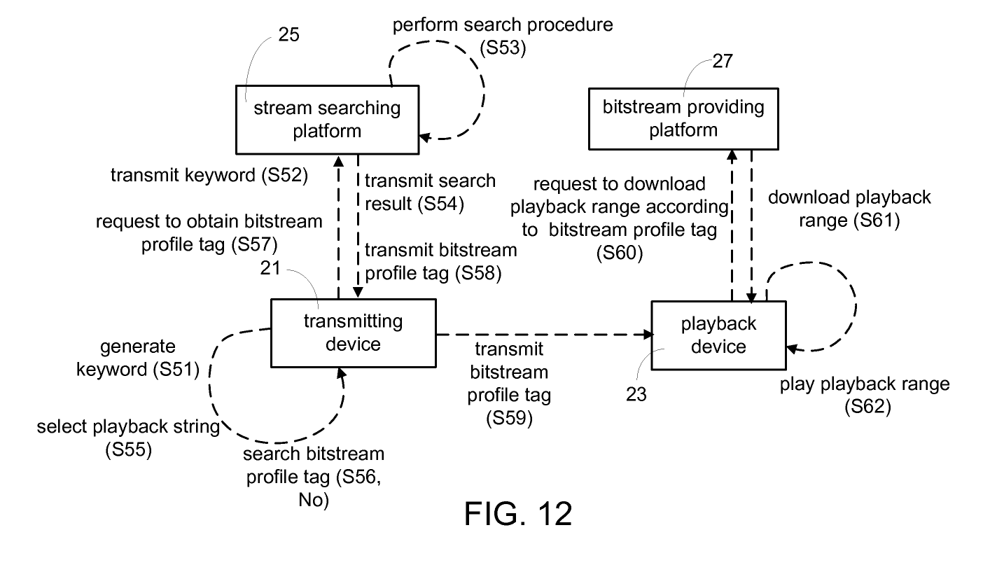

In the embodiment of FIG. 10, it is assumed that the transmitting device 21 had stored the bitstream profile tag. In the embodiments of FIGS. 11 and 12, it is assumed that the transmitting device 21 has never stored the bitstream profile tag. In FIG. 11, it is assumed that the playback device 23 previously stored the bitstream profile tag and the stream clip. In FIG. 12, on the other hand, it is assumed that the playback device 23 obtains the stream clip from the stream providing platform 27 according to the bitstream profile tag.

FIG. 10 is a schematic view showing a communication system implementing a communication method according to one embodiment. First, after generating the keyword according to the user's input (step S31), the transmitting device 21 transmits the keyword to the stream searching platform 25 (step S32). After performing the search procedure (step S33), the stream searching platform 25 transmits the search result to the transmitting device 21 (step S34). The transmitting device 21 lets the user select the playback string from the candidate paragraph (step S35). After the playback string is selected, it is confirmed whether the storage unit 215 had stored the bitstream profile tag corresponding to the playback string (step S36).

This embodiment assumes that the transmitting device 21 had previously stored the bitstream profile tag. Therefore, the transmitting device 21 can directly transmit the bitstream profile tag to the playback device 23 (step S37). After receiving the bitstream profile tag, the playback device 23 reads the playback identifier field of the bitstream profile tag. Next, the playback device 23 compares the read playback identifier with the content of the storage unit 235. It is assumed that the storage unit 235 has stored the same playback identifier, and it represents that the storage unit 235 also stores the playback range corresponding to the bitstream profile tag. Therefore, the playback device 23 can start to play the target stream according to the playback range (step S38).

FIG. 11 is a schematic view showing a communication system implementing a communication method according to another embodiment. Referring to FIG. 11, the steps S41 to S45 are similar to the steps S31 to S35 of FIG. 10, and will not be further described here.

This embodiment assumes that the transmitting device 21 does not store the bitstream profile tag corresponding to the playback string (step S46). Therefore, the transmitting device 21 is changed to request the stream searching platform 25 to obtain the bitstream profile tag (step S47). After the stream searching platform 25 transmits back the bitstream profile tag (step S48), the transmitting device 21 transmits the bitstream profile tag to the playback device 23 (step S49). Similarly, it is assumed that after receiving, the playback device 23 confirms that the inside has stored the playback range corresponding to the bitstream profile tag. Therefore, the playback device 23 can start to play the target stream according to the playback range (step S50).

According to FIGS. 10 and 11, it is obtained that the method of the transmitting device 21 adopting the idea of the invention for actually obtaining the bitstream profile tag needs not to be restricted. For example, the transmitting device 21 can obtain the bitstream profile tag through the stream searching platform 25, and then transmit the bitstream profile tag to the playback device 23 (see FIG. 11). Alternatively, the transmitting device 21 may also store the bitstream profile tag in advance (see FIG. 10). When the later method is adopted, and the user A and the user D use the instant messaging software in the future, and if the user A happens to transmit the same video clip, the user A can directly transmit the bitstream profile tag to the playback device (not shown) of the user D.

FIG. 12 is a schematic view showing a communication system implementing a communication method according to still another embodiment. Referring to FIG. 12, the steps S51 to S59 are similar to the steps S41 to S49 of FIG. 11, and will not be described here.

This embodiment assumes that the playback device 23 does not store the playback range. Therefore, the playback device 23 requests the stream providing platform 27 to download the playback range according to the bitstream profile tag (step S60). After downloading the playback range (step S61), the playback device 23 plays the playback range (step S62). It is to be noted that the playback device 23 may also selectively store the playback range according to the preferences of the user B.

If the playback device 23 has stored the playback identifier and the playback range, and the playback device 23 happens to receive the playback range again in other occasions, the time of transmitting the stream clip can be saved. For example, it is assumed that the user C wishes to share the same playback range with the user B when the user C and the user B use the instant messaging software in the future. At this time, after the transmitting device (not shown) of the user C transmits the bitstream profile tag to the playback device 23 of the user B, the playback device 23 of the user B can search the internal storage unit according to the playback identifier in the bitstream profile tag. If the storage unit 235 has stored the playback identifier, then the playback device 23 can directly play the target stream according to the playback range.

It is to be noted that the implementing details of the playback method of the invention can be modified freely. For example, the stream searching platform 25 may also provide the search function for the specific video type and the like according to the users interest and preferences. Furthermore, the transmitting device 21 and the playback device 23 may also adjust the operation flow according to the users habit. These modified methods are not restricted to the embodiments, but may be freely applied by those skilled in the art.

For example, when the user A habitually uses some video clips, the transmitting device 21 can provide the function of the internal search with the high priority. That is, after the user inputs the keyword, the transmitting device 21 can search the bitstream profile tag in its storage unit according to the keyword.

In another example, when the transmitting device 21 selects and transmits the playback string to the stream search platform, the transmitting device 21 may also transmit the identification method (for example, Line ID or the like) of the playback device to the stream searching platform 25. Thus, the stream searching platform 25 can directly transmit the bitstream profile tag to the playback device 23 without forwarding the bitstream profile tag through the transmitting device 21.

In still another example, when the electronic device functions as the transmitting device and the playback device concurrently, the electronic device stores the bitstream profile tag and the playback range of the target stream. Therefore, when the electronic device functions as the transmitting device, the electronic device may also directly and concurrently transmit the bitstream profile tag and the playback range of the target stream to the corresponding playback device without through the stream searching platform.

According to the idea of the invention, the playback method performed according to the bitstream profile tag is proposed. According to the bitstream profile tag, the instant messaging software can obtain the information, such as where the target stream is obtained, and which part of the target stream should be played (start from which time instant and end at which time instant). The feelings and the emotions that can be expressed by the video clip are far better than those of the currently used icon or text. Therefore, the bitstream profile tag according to the present invention significantly reduces the required bandwidth when the instant messaging software keeps sharing the video clip. Thus, the instant messaging software adopts the communication method of the invention can attract a lot of users.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication system, comprising:
a transmitting device for transmitting a bitstream profile tag; and
a playback device, in communication with the transmitting device, for receiving the bitstream profile tag and accordingly plays a playback range of a target stream.

2. The communication system according to claim 1, wherein the transmitting device stores the bitstream profile tag in advance, or the bitstream profile tag is received form a stream searching platform.

3. The communication system according to claim 1, wherein the playback device plays the playback range on line, or downloads the playback range.

4. The communication system according to claim 1, further comprising:
a stream searching platform, in communication with the transmitting device, wherein the stream search platform comprises:
a mapping unit, for storing a plurality of full text strings and relationships between the plurality of full text strings and a plurality of original streams.

5. The communication system according to claim 4, wherein the relationships represent corresponding manners between each of the plurality of full text strings and playback timing of each of the plurality of original streams.

6. The communication system according to claim 4, further comprising:
a stream providing platform, in communication with the stream searching platform and the playback device, for storing the plurality of original streams, wherein the target stream is one of the original streams.

7. The communication system according to claim 4, wherein after receiving a keyword generated by the transmitting device, the stream searching platform generates the bitstream profile tag according to the keyword.

8. The communication system according to claim 4, wherein after receiving a keyword generated by the transmitting device, the mapping unit performs a search procedure on the plurality of full text strings according to the keyword.

9. The communication system according to claim 8, wherein the mapping unit obtains a plurality of candidate full text strings comprising the keyword through the search procedure, and then excerpts a portion, comprising the keyword, from the candidate full text strings as a plurality of candidate paragraphs, and transmits the plurality of candidate paragraphs to the transmitting device.

10. The communication system according to claim 9, wherein after receiving the plurality of candidate paragraphs, the transmitting device selects a playback string from one of the plurality of candidate paragraphs, and transmits the playback string to the stream searching platform.

11. The communication system according to claim 10, wherein the playback string is an aside string, a subtitle string or a lyric string corresponding to the playback range.

12. The communication system according to claim 10, wherein the stream searching platform further comprises:
a label generating unit for generating the bitstream profile tag according to the playback string.

13. The communication system according to claim 12, wherein the bitstream profile tag comprises: a storage position of the target stream, the playback range, the playback string and a playback identifier.

14. A transmitting device in communication with a playback device, the transmitting device comprising:
an input unit for inputting a keyword; and
a transmitting unit for transmitting a bitstream profile tag generated according to the keyword, wherein the playback device plays a playback range of a target stream according to the bitstream profile tag.

15. The transmitting device according to claim 14, further comprising:
a storage unit for storing the bitstream profile tag.

16. The transmitting device according to claim 14, wherein the transmitting device is in communication with a stream searching platform, and the transmitting device further comprises:
a receiving unit, in communication with the stream searching platform, for receiving a plurality of candidate paragraphs, wherein the plurality of candidate paragraphs are generated by the stream searching platform according to a search procedure.

17. The transmitting device according to claim 16, wherein in the search procedure, the stream searching platform obtains a plurality of candidate full text strings, comprising the keyword, from a plurality of full text strings, and excerpts a portion comprising the keyword from the plurality of candidate full text strings as the plurality of candidate paragraphs.

18. The transmitting device according to claim 16, wherein the input unit selects one of the plurality of candidate paragraphs and decides a playback string in the selected candidate paragraph, and the transmitting unit transmits the playback string to the stream searching platform.

19. The transmitting device according to claim 18, wherein the playback string is an aside string, a subtitle string or a lyric string corresponding to the playback range.

20. The transmitting device according to claim 14, wherein the bitstream profile tag comprises: a storage position of the target stream, the playback range, a playback string and a playback identifier.

21. A playback device in communication with a transmitting device, the playback device comprising:
a receiving unit for receiving a bitstream profile tag transmitted by the transmitting device; and
a playback unit for playing a playback range of a target stream according to the bitstream profile tag.

22. The playback device according to claim 21, wherein the playback device plays the playback range on line, or downloads the playback range.

23. The playback device according to claim 21, wherein the bitstream profile tag comprises: a storage position of the target stream, the playback range, a playback string and a playback identifier.

24. A playback method applied to a playback device, the playback method comprising the steps of:
selecting a target stream according to a bitstream profile tag; and
playing a playback range of the target stream according to the bitstream profile tag.
